(19) United States
(12) Patent Application Publication
(10) Pub. No.: US 2005/0125273 A1
(43) Pub. Date: Jun. 9, 2005

(54) System and method for interactive coordination of time schedules and project opportunities

(76) Inventors: William L. Simons, Oak Park, CA (US); Abel Calderon JR., Ventura, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/727,968

(22) Filed: Dec. 4, 2003

(51) Int. Cl. G06F 17/60

(52) U.S. Cl. 705/8

(57) ABSTRACT

A method and system for providing an interactive computer-driven project management coordination service in which project providers can advertise available jobs, projects, or projects on the Internet and service providers can display information about time schedules and availability. The method and system enables project and service providers to access via the Internet the data stored, to search said data for purposes of matching and coordinating projects with the requisite services, and to delete or alter said data as projects or time schedules change from day to day.

### BACKGROUND OF THE INVENTION

1. Field of the Invention

The present invention relates in general to the field of interactive computer-driven project and scheduling services, and more particularly to a system and method for the management and coordination of the time schedules and availability of individuals in connection with project opportunities. The system enables project providers and service providers to post and review short and long term projects, thereby facilitating the process of locating and matching available and qualified service providers for specific projects having immediate deadline situations.

2. Description of Related Art

Prior art exists for websites that allow individuals and companies to post job openings and to manage employment recruitment. U.S. Pat. No. 6,385,620 B1 teaches employment software for the management of candidate recruiting information and for facilitating the electronic processing of data regarding candidate qualifications for job positions. U.S. Pat. Nos. 5,978,768 and 6,370,510 teaches computer network systems for employment recruiting services by which job positions can be advertised and candidates may submit resumes. Such software does not allow individuals to post time schedules and availability for purposes of searching or matching time with project information.

Websites for dating are also prevalent in prior art, most of which allow a person to post a personal profile. Such sites do not provide for the coordination of a person's time schedule with the posted project opportunities.

Other prior art exists in the area of auction and jamboree websites. U.S. Pat. No. 5,845,265 and in continuation U.S. Pat. No. 6,085,176 teach a computerized method for the purchase and resale of used and collectible goods by which a party may speculate on a sale by changing the price and reselling the items. U.S. Pat. No. 6,266,651 provides for a system of selling inventory in two separate market tiers having different terms of sale. These websites allow individuals to post tangible items for sale and provide a system of bidding by purchasers. These systems do not, however, provide for the coordination and management of time schedules and project opportunities. Furthermore, while both systems involve “bidding,” they differ in the fact that the auction websites provide for the immediate secure transfer of money, which is not an issue in the posting and acceptance of project positions.

Project management systems are available in prior art for the coordination of work projects among employees. U.S. Pat. No. 6,604,124 B1 teaches a system and method for computerized management of work flow and for tracking the completion of projects. Such systems do not coordinate the schedules of different service providers for purposes of locating service providers who can complete particular projects.

In some prior art systems, individuals are able to post comments, pictures, and advertisements through bulletin boards, classifieds, or “chat rooms.” However, these systems do not provide for the same data collection and do not operate in the same way as systems that provide for the posting and coordination of time schedules and project opportunities.

Gaming and sports websites have been developed for the posting of the schedules of teams and other groups, but these sites are merely listing of play times. They are not designed for the posting and managing of an individual's time schedule and availability, and they do not provide for the posting, searching, and coordination of project opportunities.

In various industries and businesses, a single project can involve the services of many different, specialized providers. For example, attorneys, insurance carriers, medical caregivers, interpreters, stenographers, photocopying services, and other service providers may all be required to complete different aspects of a single project related to an administrative or court proceeding. As another illustration, various contractors, subcontractors, and sub-subcontractors, suppliers, transport companies, inspectors, appraisers, insurers, and others may be required to complete a home-building project. In many situations, time is of the essence, and it is necessary to locate quickly those providers who are available and specifically qualified for the specialized nature of a particular aspect of a project. In the past, this process has usually been accomplished inefficiently by means of telephone inquiries to advertised providers, publication of announcements or advertisements seeking service providers, retention of resume or card files for providers previously utilized, or referrals of providers recommended through business networking contacts. There remains a need for a time- and cost-efficient system, preferably computerized and internet-accessible, that allows for coordination of the schedules of qualified and available service providers with project opportunities that need to be completed within a specific, and often short, time frame.

### BRIEF SUMMARY OF THE INVENTION

The present invention consists of an interactive website designed and developed to facilitate and enhance the relationships of persons who use the website. This website allows an individual to log onto the website and use the tools provided for coordinating their time schedules and availability with project assignment opportunities. Individuals using the website can search the availability and time schedule features and the project opportunities. The system offers users the ability to coordinate and manage these two aspects of a business relationship.

It is an object of the present invention to provide a system and method whereby individuals have the availability of posting and searching for both schedules and availability and for projects all in a singe website.

An object of the present invention is to enable project providers to advertise specific and specialized aspects or projects of a larger project and to locate via a centralized and computerized system a service provider that is qualified and available at a stated time to handle the specialized aspect or assignment.

A further object of the present invention is to enable service providers to display their time schedules and availability for specialized projects and to locate via a centralized and computerized system a project provider that requires said services.

An aspect of the present invention is that project and service providers can coordinate and manage projects via a time- and cost-efficient means that matches within a single system and method the two essential components of a business relationship, namely a project opportunity with an available and qualified service provider.

A further aspect of the present invention is that a service provider may search for other service providers having different qualifications and may even advertise as a project provider when a project requires additional expertise from another service provider, and thus this invention offers service providers the ability to coordinate among themselves to complete projects that require assistance from multiple providers having various skills, knowledge, licenses, and expertise.

Another object of the present invention is to provide a method and system that is easy to access and utilize, that stores and displays only immediately relevant data in a quickly scannable and organized presentation, and that allows users personal expression within the guides of the system.

A more complete understanding of the present invention and the advantages thereof may be understood by referring to the following description taken in conjunction with the accompanying drawings.

### BRIEF DESCRIPTION OF THE DRAWINGS

FIG. 1 illustrates a system and method for computerized listings of projects opportunities by project providers in connection and coordination with listings of time schedules and availability by service providers.

FIG. 2 illustrates an embodiment of the database server for the present invention.

FIG. 3 illustrates a flowchart of a method for initiating interactive use of the system of FIG. 1.

FIG. 4 illustrates a flowchart of a method for presenting system options to users or members of the system of FIG. 1.

FIG. 5 illustrates a flowchart of a procedure by which a service provider may enter or post time schedule and availability data to the system of FIG. 1.

FIG. 6 illustrates one embodiment of a schedule posting form that can be used by a service provider when using the posting procedure shown in FIG. 5.

FIG. 7 illustrates a flowchart of a method for presenting a service or project provider with a procedure for browsing or searching the current schedule records stored in the system of FIG. 1.

FIG. 8 illustrates one embodiment of a schedule search form used to enter data for performance of the search procedure shown in FIG. 7.

FIG. 9 illustrates one embodiment of a search results form returned by execution of the search procedure for schedules shown in FIG. 7.

FIG. 10 illustrates a flowchart of a method for presenting a project provider with a procedure for entering or posting a project opportunity in the system of FIG. 1.

FIG. 11 illustrates one embodiment of a project posting form that can be used by a project provider when using the posting procedure shown in FIG. 10.

FIG. 12 illustrates a flowchart of a method for presenting a project or service provider with a procedure for browsing or searching the current records for project opportunities stored in the system of FIG. 1.

FIG. 13 illustrates one embodiment of a project search form used to enter data for performance of the search procedure shown in FIG. 12.

FIG. 14 illustrates one embodiment of a search results form returned by execution of the search procedure for projects shown in FIG. 12.

FIG. 15 illustrates a flowchart of a method for presenting a project or service provider with a procedure for editing or deleting data stored in the system of FIG. 1.

FIG. 16 illustrates one embodiment of a schedule selection result form utilized in the schedule editing and deleting procedure shown in FIG. 15.

FIG. 17 illustrates one embodiment of a schedule editing form that can be used by a service provider when using the schedule editing and deleting procedure shown in FIG. 15.

FIG. 18 illustrates one embodiment of a project selection result form utilized in the project editing and deleting procedure shown in FIG. 15.

FIG. 19 illustrates one embodiment of a project editing form that can be used by a project provider when using the project editing and deleting procedure shown in FIG. 15.

### DETAILED DESCRIPTION OF THE INVENTION

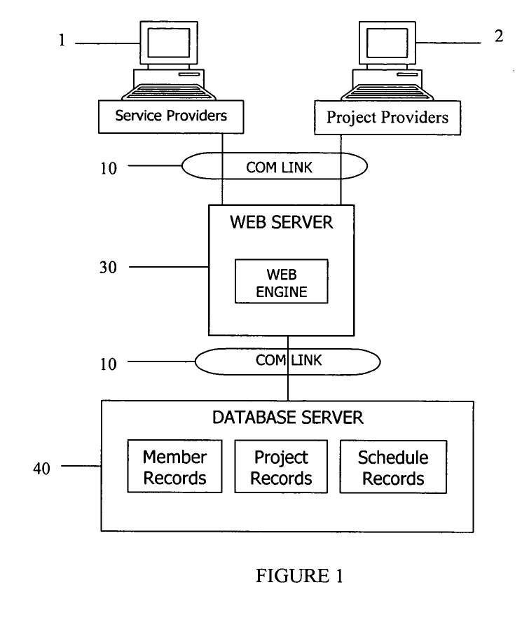

Referring to FIG. 1, the present invention is illustrated as a system for computerized coordination of projects and time schedules. In general, the system accepts Member Profiles from service providers (1) and project providers (2). For each provider who becomes a member or registrant of the system, the system stores the profile in a Member Record in the Database Server (40). At any time after becoming a member or registrant of the system, a project provider (2) or service provider (1) may submit data to the system. Data for a project is stored in a Project Record in the Database Server (40) in the system. Data for a time and availability schedule is stored in a Schedule Record in the Database Server (40). A member may access the system to search the data records for purposes of coordinating and managing projects with time schedules, and the member may edit or delete any Project Record or Schedule Record that the member has submitted for storage in the Database (40).

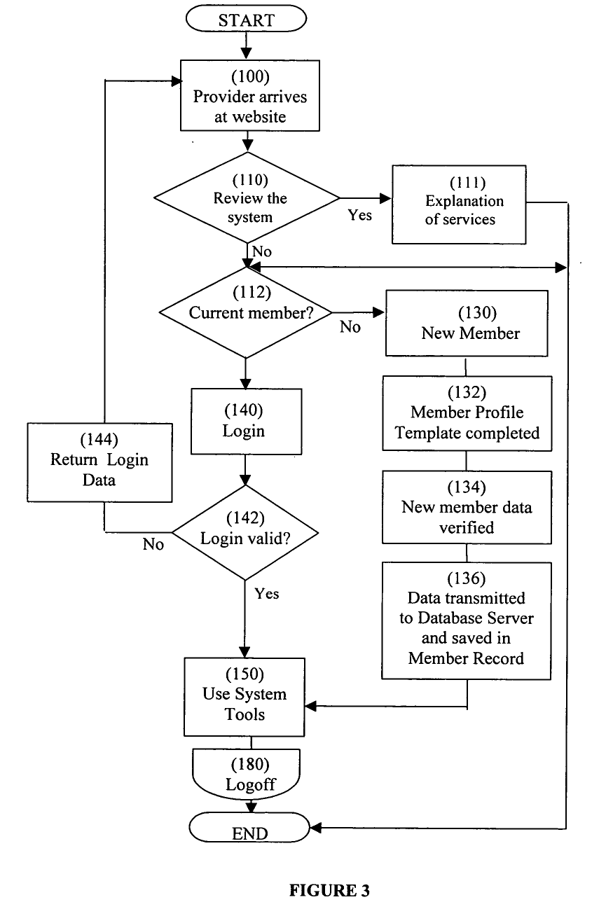

In specific operation of the system, a service provider (1) or project provider (2) utilizes a computer device to access via a communications link (10) the system web engine residing on the web server (30). The provider initially enters data into a Member Profile Form generated by the web engine (30), consisting of a software module contained on the web server (30). This process is further illustrated in FIG. 3. The Member Profile information may be communicated by the web engine software on the Web Server (30) to the Database Server (40) via a communications link (10) for processing, indexing, and storing as a Member Record on the Database Server (40).

After a provider's Member Profile has been submitted and stored in a Member Record in the Database Server (40), the provider is qualified as a member of the system, which allows the member provider access to the web engine residing on the Web Server (30) for purposes of submitting project or time schedule data. Said submissions may be received by the web engine on the Web Server (30) and communicated to the Database Server (40) for processing, indexing, and storing as Project Records or Schedule Records, respectively, using the software modules residing on the Database Server (40). A provider who has a Member Profile may access the system via the web engine on the Web Server (30) in order to search, browse, review, edit, and delete submitted project and schedule information, which procedures are further illustrated in FIGS. 3 through 19. In one embodiment of the system, a provider may also have access to a messaging procedure wherein a provider may select a topic and submit or post a message containing questions or comments relevant to said topic, which message may be reviewed by other providers who are members of the system, any of whom may use the messaging procedure to submit further messages containing answers or other comments. In another embodiment of the system, a provider may access a procedure that displays and allows usage of templates of forms that are commonly used in the relevant trade or industry, such as letters, government or court applications, petitions, or forms, or contractual documents.

The system in FIG. 1 includes a Web Server (30) in communication with one or more project providers (2) and service providers (1). It also includes a Database Server (40) in communication with the Web Server (30). Communication between these components of the system may be implemented using hardware and software associated with one or more communication links (10). FIG. 1 illustrates the system as being a client/server environment, but each system component may be any type of computer operating in any suitable environment that communicates using one or more communication links. For example, the components could be arranged in a peer-to-peer computing environment or any another environment that suitably supports communication among the different components.

The project providers (2) and service providers (1) and the Web Server (30) and Database Server (40) may operate on one or more computing devices with input and output modules by which a provider may enter and view data. Examples include workstations, client computers, terminals, and personal computers. Said devices may include web browsers and other user interfaces, memory, processing components, and peripherals common to computing devices. Input devices may include keypads, touch screens, mouse devices, or other devices that can be used to enter information into a computer system. Output devices include monitors and other output devices that convey information associated with the system, including digital, visual, and audio data. A computer processor and its related memory execute instructions and manipulate data pursuant to the operation of the system. For example, the processor may execute coded instructions that are stored in memory on data that is also stored in the memory.

The Web Server (30) and Database Server (40) may comprise general-purpose computers or other computing platforms having processor and memory components. Alternatively, they may be any combination of hardware and software that includes components suitable for processing and storing data-encoded instructions. The Web Server (30) and Database Server (40) may be physically separate servers communicating through a communication link (10) as illustrated, or they may reside on a single common server and be separate merely in function. In its preferred embodiment, the Database Server (40), whether or not the same physical server as the Web Server (30), would also include software modules or components that insulate and secure the database software and server from public network access, such as a firewall or similarly suitable means of security. Thus, the components of the Database Server (40) can be secured while the components of the Web Server (30) can be freely or selectively accessed over the communication links with the public communications network.

Software modules, including web engines and other suitable components, reside on the Web Server (30) and provide the necessary processing routines, user interfaces, and forms to allow project (2) and service (1) providers who access the website on the Web Server (30) to utilize the system for performing the respective functions further illustrated with reference to FIGS. 3 through 19. Similarly, software modules, including database engines and other suitable components, reside on the Database Server (40) and provide the necessary processing, filtering, indexing, and storing of member data, project data, and time schedule data, respectively.

Any of the communication links (10) may be dedicated or switched links of a private or public network. To illustrate, the communication links may be implemented using a fiber, cable, or twisted-pair connection over a public-switched telephone network, a satellite, radio, microwave, or other wireless link, or other suitable communication link between the system components. The system components may be part of any suitable network or interconnection of computing devices, such as a local area network (LAN) or a wide area network (WAN). In one embodiment, components in the system communicate over the Internet using the World Wide Web (WWW), a File Transfer Protocol (FTP), any of a variety of link utilities software, mobile objects, electronic mail, bulletin boards, or other suitable communication techniques. For example, project providers (2) and service providers (1) may maintain and execute on their own personal computing devices a browser or other suitable parsing program for accessing and communicating data that is addressed by Uniform Resource Locations (URLs) using one or more communication links.

The system components may be implemented in a programming environment that supports access or linking by means of URL addresses. As such, the content of system modules and databases may be constructed using Hypertext Mark-Up Language (HTML), Standard Generalized Mark-Up Language (SGML), Virtual Reality Mark-Up Language (VRML), Java Script, or any other appropriate content development language. The system modules may include program code and other appropriate self-executing code.

In the Web Server (30) and Database Server (40), and within the computing devices of the project providers (2) and service providers (1), the memory utilized may comprise one or more files, data structures, lists, or other arrangements of information stored by any suitable and convenient means. Examples include one or more components of random access memory (RAM), read-only memory (ROM), magnetic computer disks, CD-ROMs, other magnetic or optical storage media, or any other volatile or nonvolatile memory. It should be understood that the databases, engines, and other software modules of the system might be internal or external to the illustrated components of the system, depending on the particular implementation, and such modules may be separated or integral to other databases. Any appropriate referencing, indexing, or addressing information can be used to relate back to an address or location of a database, file, or object within the system.

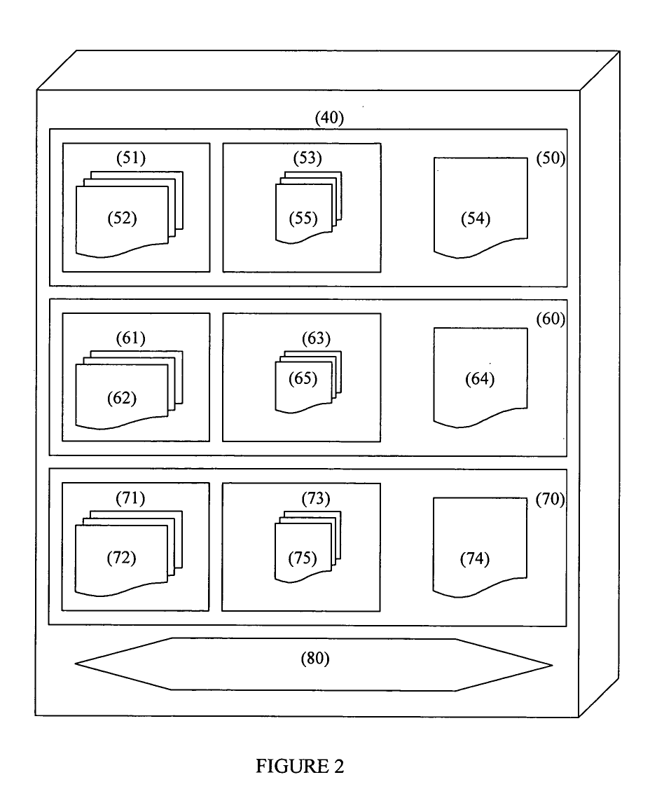

FIG. 2 illustrates a more detailed embodiment of the Database Server (40), showing a Member Engine (50), a Project Engine (60), a Schedule Engine (70), and a Filter Engine (80).

In the illustrated embodiment, the Member Engine (50) includes a Member Record Database (51), a Member Review Template (54), and a Member Map (53). A plurality of Member Records (52) are generated from the Member Profiles input by project and service providers utilizing the web engine on the Web Server, as illustrated in FIG. 1. Each Member Record (52) is stored in the Member Record Database (51) when submitted by the Web Server. For example, a provider accessing the web engine on the Web Server may make a selection to become a system member, in which event the web engine displays a Member Profile Template into which the provider enters qualification data. The web engine on the Web Server transfers the data entered to the Member Engine (50) on the Database Server (40), where the Member Engine (50) organizes and stores it in a Member Record (52) of the Member Record Database (51). By storing the data in a Member Record (52), the system allows a provider to access the same data in the future without having to re-enter the qualification data.

The Member Review Template (54) is a form generated by the Member Engine (50). The Member Review Template (54) includes fields used in the Member Record (52) to store member qualification data submitted via a Member Profile Template generated by the web engine. A provider may access and review the data by submitting a request to the web engine on the Web Server, which request is then communicated by the web engine to the Member Engine (50) on the Database Server (40). On receipt of the submitted request, the Member Engine (50) generates a Member Review Template (54) containing the data previously sorted for the particular member in the member's Member Record (52) in the Member Record Database (54). A member of the system may also submit a request to access and review the Member Records of other members of the system, in which event a Member Review Template may also be generated by the Member Engine (50) for this purpose, although the fields displayed in such Member Review Template may be more limited to avoid display of secured data relevant to any particular member.

The embodiment in FIG. 2 limits access to the system tools to project and service providers who have become members or registrants of the system. Thus, a provider may access the system only if the provider has entered required qualification data, which data must be confirmed by the Filter Engine (80) before access to the full system is permitted. In another embodiment of the system, access to the full system may be further limited to providers who have become paid members of the system. Yet another embodiment of the system is to offer unlimited access to the system without any requirement of paid or unpaid membership or registration.

The Filter Engine (80) is a software module or other suitable combination software and/or hardware operable to screen member profile data entered into the Member Profile Template in the web engine on the Web Server before such data is stored in a Member Record (52) in the Member Record Database (51). In one embodiment, the Filter Engine (80) includes automated benchmarks by which member qualification data in a Member Profile Template is evaluated before being approved. For example, the first level of benchmarks may simply confirm that valid member qualification data has been entered in each field of the Member Profile Template in the web engine. A more complex evaluation may include determining whether or not the member profile data demonstrates a particular level of competency or experience required for using the system.

For the data stored in a Member Record (52), a Member Mapping Engine (53) generates a plurality of Member Identifiers (55). Each Member Identifier (55) consists of unique data, such as alphanumeric strings, utilized to index a particular member's qualification data. For example, a particular Member Record (52) may be parsed for member qualification data related to name, geography, industry or trade, and technical qualifications or educational background. The parsing results in assignment of Member Identifiers (55), which are used by the Member Mapping Engine (53) to index and list the members of the system by categories corresponding to their qualifications. The Member Mapping Engine (53) is capable of producing a list or chart, referred to as a Member Map, showing all members of the system with the specific qualifications mapped. The Member Map may be a single or multi-dimensional index having one or more tiers or levels of member qualification data under which the Member Records (52) are listed by a plurality of Member Identifiers (55). The Member Map may include hypertext links or other selectable inputs that, when selected, operate to display a particular member's Member Review Template (54) showing selected qualification data for that member. In this procedure, any member of the system may review relevant data about other system members.

In the illustrated embodiment in FIG. 2, the Projects Engine (60) includes a Project Record Database (61), a Project Review Template (64), and a Project Mapping Engine (63), while the Schedule Engine (70) includes a Schedule Record Database (71), a Schedule Review Template (74), and a Schedule Mapping Engine (73). The Project Engine (60) and Schedule Engine (70) of the present invention operate in similar fashion to the Member Engine (50), with the primary distinction being the data that each Engine enters, organizes, and stores into the system. Each Database (61) and (71) is composed of a plurality of Project Records (62) or Schedule Records (72), respectively, which are created to store data submitted to the respective Database (61) of (71) through Project Profiles or Schedule Profiles generated by the web engine on the Web Server and completed by project or service providers while accessing the web engine as illustrated in FIG. 1. In particular, a party offering a project (project provider) utilizes the web engine on the Web Server to enter and submit data about the opportunity offered by means of the Project Profile Template, while a party offering a service (service provider) utilizes the web engine on the Web Server to enter and submit data about the service and time schedule availability by means of the Schedule Profile Template. Said data is organized and stored as Records (62) and (72) in the respective system Databases (61) and (71) for Projects and Schedules. A provider may review the data for Projects or Schedules by means of the respective Review Templates (64) and (74).

The Project Records (62) or Schedule Records (72) may be reviewed as organized by the date of submission to the system. Alternatively, a Project Mapping Engine (63) or Schedule Mapping Engine (64) may be utilized to generate Project Identifiers (65) or Schedule Identifiers (65) respectively and in similar fashion to the Member Mapping Engine (53) utilized for the member qualification data described previously. Similarly, a filter engine (80) may be used to screen project and schedule data being input into the system, as described previously for member qualification data.

In FIG. 3, a provider's initial contact with the present invention is represented in a flow chart. When a service or project provider arrives at the website address and accesses through a user interface a representation of the website on the web server (100), the provider has the option (110) of reviewing information about the system and the tools available (111). Such information may include system features, general industry or trade information, system policies and terms, hyperlinks, and management contact information and hyperlinks. In one embodiment of the system, a provider may also have access to a messaging procedure and/or a form template procedure as described in FIG. 1, previously. At any time during the review process, the provider may choose to exit the system. Alternatively, the provider may opt to enter the system (112) by choosing to login as a current member (140) or by enrolling as a new member (130). If the provider initially chooses not to review the system (110), the provider has the option of exiting the system, logging in as a current member (140) or enrolling as a new member (140). All options allow the provider access to additional functionality within the system. When the provider selects an option, an input corresponding to the selection is received by the web engine on the Web Server.

In step 112, the web engine compares the provider's input selection to user option identifiers to determine if the provider selected the option to become a new member (130). If so, the provider is presented with a Member Profile Template (132) generated by the web engine on the Web Server. The provider will be asked to enter qualification data. The qualification data includes relevant information about the provider such as contact and background information, industry or trade data, education, special training, individual preferences, geographical location, working environment, and wages. The Member Profile Template may permit the provider to enter textual content into fields or dialog boxes, and it may permit the provider to select pre-programmed options in the Template. The Template may also include links, pop-up windows, selectable options or icons, highlightable data items, or information otherwise generated by the system. When the provider submits the qualification data by selecting a submission button or other indicator, the system may verify the data (134), which is then saved into the Member Database as a Member Record for that particular provider (136) so that the data can be accessed and reviewed in the future. This data may include an identifying name and password for security purposes. In one embodiment of the system, the system generates a data confirmation form for the provider to review the data as input and to make corrections to it prior to submission. When the data is saved, the Member Mapping Engine immediately parses the data and generates unique Member Identifiers for the Member Record for indexing, review, and retrieval purposes, as described in FIG. 2. After the Member Record has been stored (136), the provider may use the system without having to log in (150) or the provider may log off and exit (180).

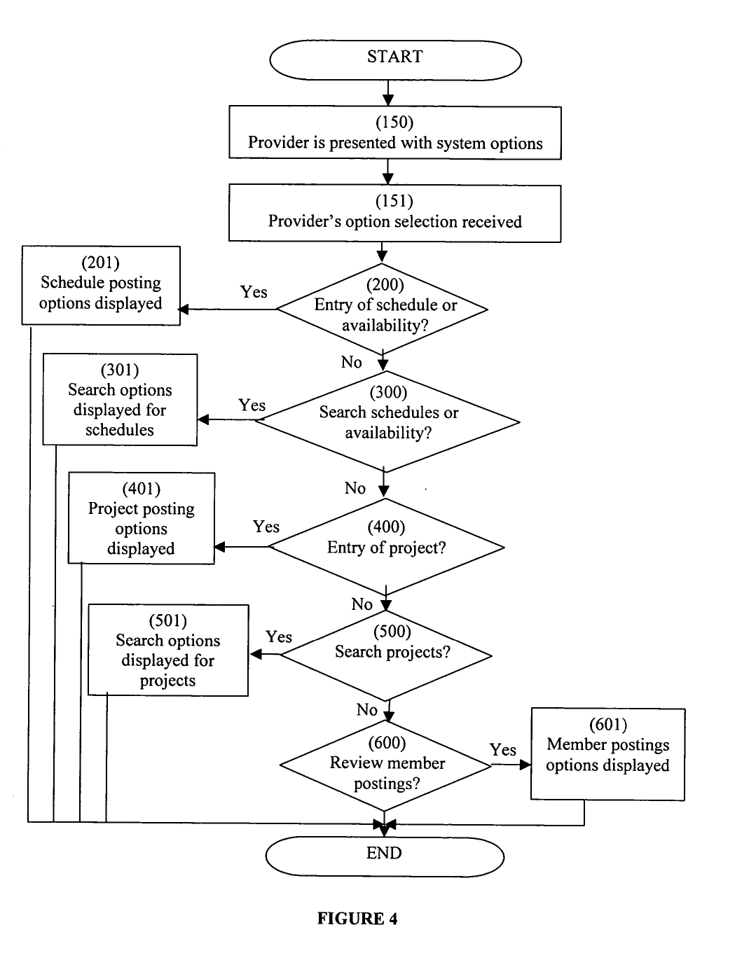

A provider who is a current member of the system may choose at step 112 to log in (140). The web engine on the Web Server will determine if the existing user login option was selected (140). If this selection was made, the provider is presented with options for existing member providers (150) as described in subsequent FIGS. 4 through 19. The system will verify the member's login information before permitting the member provider access to the system (142). If the member provider has forgotten the selected password, the member provider has the option of requesting that the system return a message (144) to the member's email account stating the previously input data for log-on as stored in the Member Record. In this case, the member provider must return to the web engine after receiving said message with the relevant information and must start the login procedure over again. After a member provider has logged into the system, the member may proceed to use the system tools (150). The member provider has the option of exiting the system at any time (180).

FIGS. 4 through 19 illustrate flowcharts and forms describing the processes and features of the system available to member providers at Step 150 in FIG. 3. Although these flowcharts refer to members of the system, membership is only one embodiment, and it is not necessary to the present invention. A registration or membership feature of the system is preferred for purposes of retaining information for the convenience of providers who repeatedly or regularly access the system and to permit such information to be reviewed by all users of the system.

In FIG. 4, the flowchart illustrates a method for presenting a member provider of the present invention with the system tools that are available to the provider. In Step 150, the member provider of the system has already entered the system, such as by accessing the web engine through a user interface and by logging in as a member, as illustrated in FIGS. 1 through 3. When the member provider arrives at Step 150, the provider is presented with a plurality of optional procedures. For example, the provider may search or review time schedules or projects, may enter schedule or project data into the system, and/or may search or review member records.

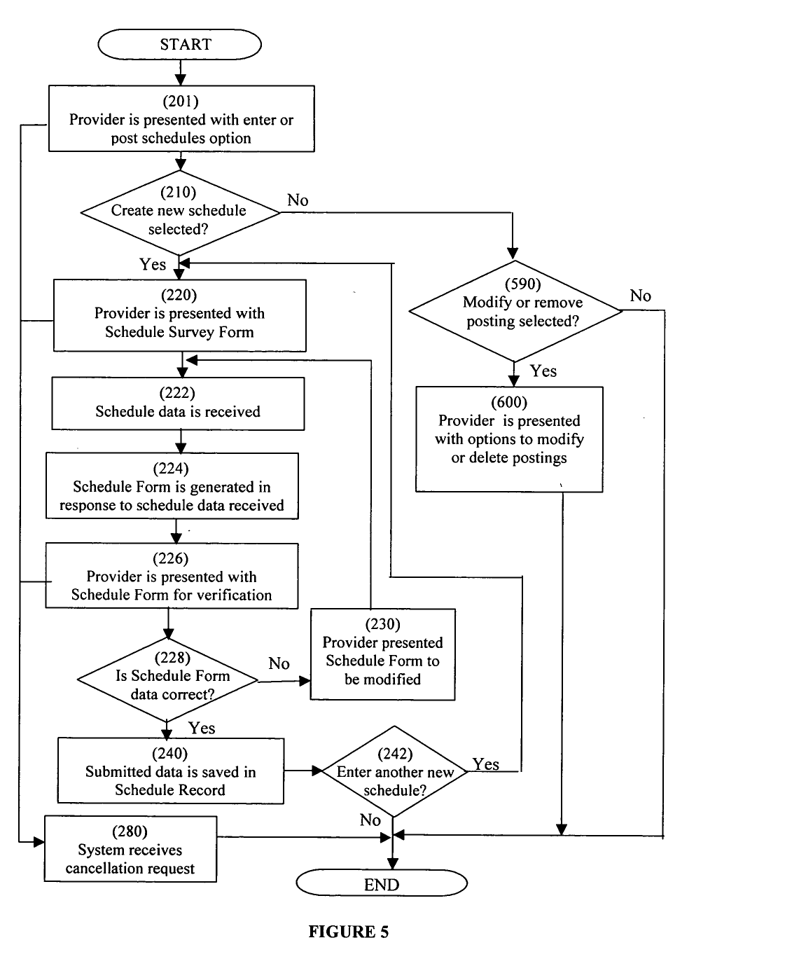

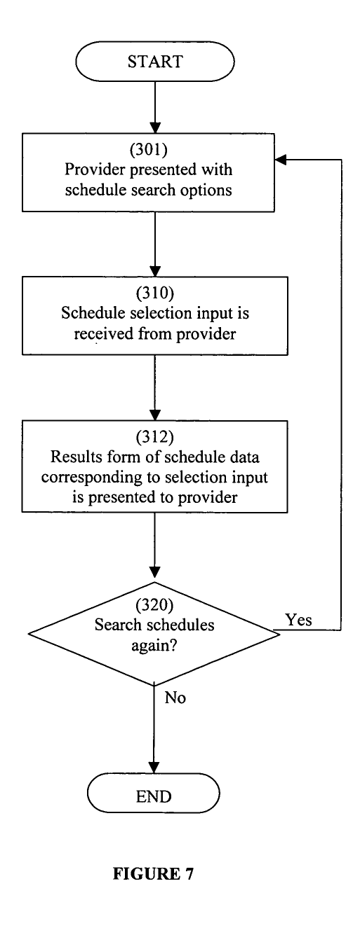

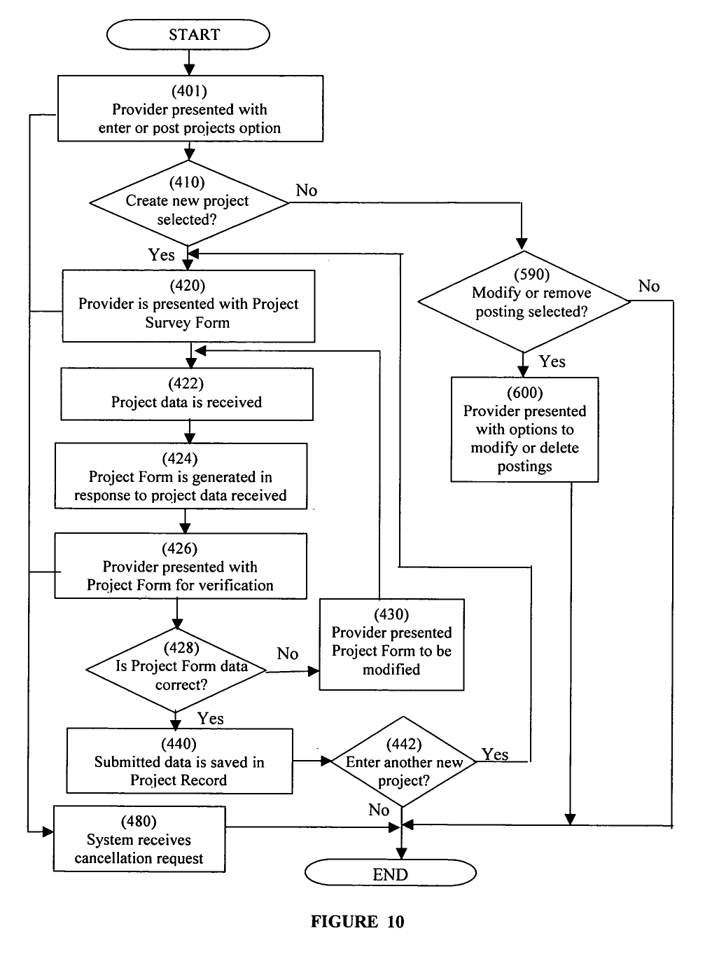

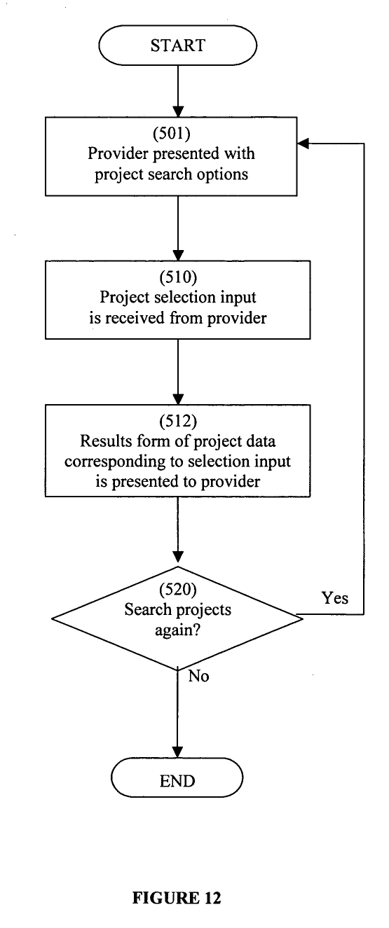

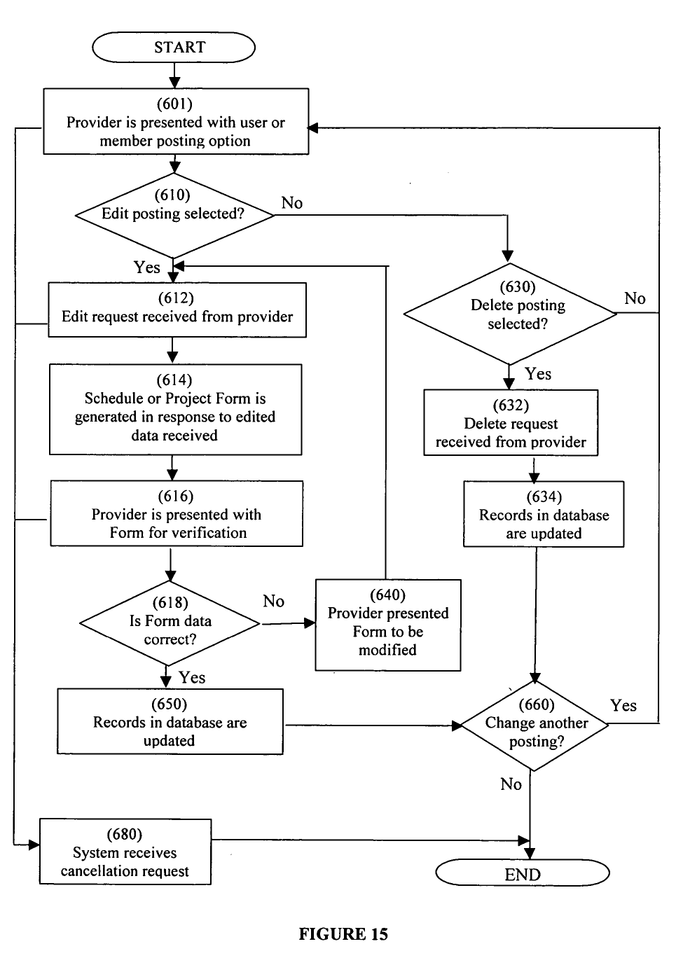

In Step 200, the web engine determines if the schedule entry or posting option was received from the provider. If this option was received, the system presents the provider with a procedure for entry of a time schedule (201), which procedure is further described in FIG. 5. If the system determines that the schedule entry or posting option was not received, in Step 300, the web engine determines whether the search and review time schedules option was received. If the search and review time schedules option was received in Step 300, the provider is presented with a procedure for searching and reviewing the time schedule records (301), which procedure is further described in FIG. 7. In Step 400, if the web engine determines that the option in Step 300 was not selected, the web engine next determines if the project entry or posting option was received from the provider. If the project entry or posting option was received, the system presents the provider with a procedure for entry of a project (401), which procedure is further described in FIG. 10. Otherwise, if the project entry or posting option was not received in Step 400, the web engine determines in Step 500 whether the provider has selected the option for searching or reviewing project records. If the web engine receives the option for searching or reviewing project records (500), the system presents the provider with a procedure to search and review project records (501), which procedure is further described in FIG. 12. If the web engine determines that the provider has not selected the option for searching or reviewing project records, in step 600, the web engine determines whether the provider has selected the option for searching and reviewing member postings to the system. If the web engine receives the option for searching or reviewing member postings (600), the system presents the provider with a procedure to search and review member postings (601), which procedure is further described in FIG. 15.

Referring to FIG. 5, a flowchart is provided to illustrate a method by which a service provider can enter and submit new time schedule and availability information into the system of the present invention. By the time the service provider arrives at Step 201, the provider has already accessed the web engine on the Web Server and proceeded to log into the system, if required, as described in FIG. 3, has selected an option to review the system tools as described in Step 150 of FIG. 3, and has selected the schedule posting options as described in Step 200 of FIG. 4. At Step 201, the web engine generates a form that describes the schedule options available and allows the provider to select whether or not to enter a new schedule into the system. The service provider is also given the opportunity to cancel the procedure, and if the web engine receives a cancellation request, the schedule option procedure will end and the web engine will redisplay the system options at Step 150 of FIG. 4.

In Step 210, the service provider makes a selection by means of a button or other indicator to enter a new schedule. If the web engine determines that a negative option has been received, in Step 590 the web engine generates a form by which the service provider may chose to modify or remove a schedule previously posted by the same provider. If the web engine again receives a negative option, the schedule option procedure will end and the web engine will redisplay the system options at Step 150 of FIG. 4. If the input received at Step 590 is determined to be a positive option, the provider is presented in Step 600 with a procedure for modifying or deleting postings, which procedure is further described in FIG. 15.

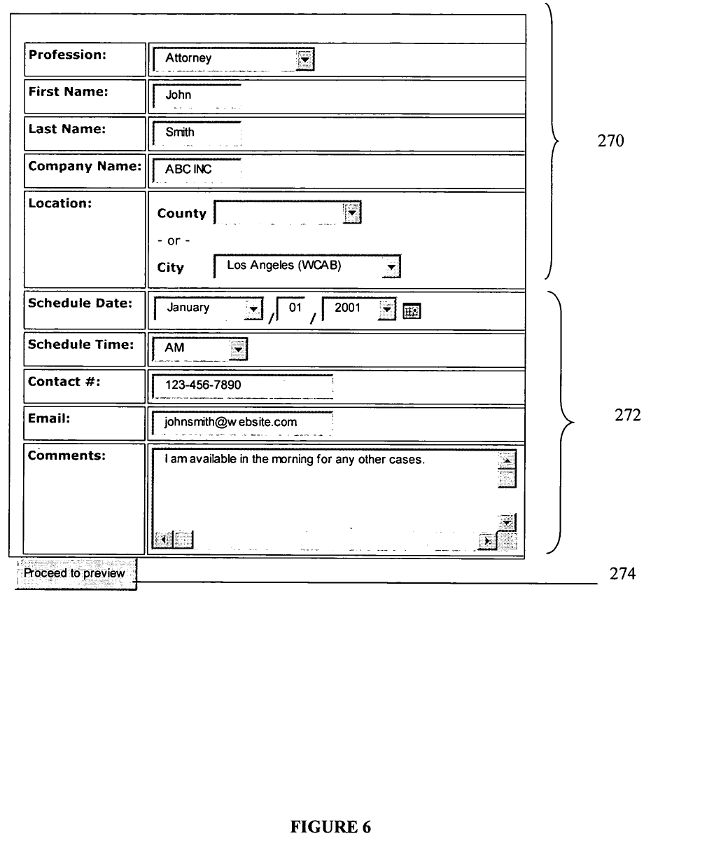

If the web engine determines that the selection input at Step 210 is a positive option, the web engine presents the provider with a Schedule Survey Form containing fields into which the service provider may enter contact and schedule data. One embodiment of a Schedule Survey Form is described in FIG. 6. The service provider may choose to cancel the procedure at any time before transmitting data to the web engine by selecting a cancel button or other indicator, in which event the web engine will end the procedure and redisplay the system options at Step 150 of FIG. 4. After the service provider has entered data and completed the Schedule Survey Form, the provider transmits the data to the web engine by selecting a submit button or other indicator.

In Step 222, the web engine receives the transmitted schedule data. In Step 224, the web engine generates a Schedule Form in response to the schedule data received, which form includes all of the data entered by the provider in Step 210 in separate fields. The generated Schedule Form is presented to the service provider in Step 226 and the provider is allowed to verify the accuracy of the data entered. At this step, the provider again may select to cancel the schedule posting procedure, in which event the web engine will end the procedure and redisplay the system options at Step 150 of FIG. 4. If the service provider does not cancel the procedure, the provider must make a selection in Step 228 to correct the data entered or to transmit the data as entered in Step 220. If the web engine determines that the provider has selected a negative option, the web engine redisplays the Schedule Form generated in Step 224 in a format such that the provider can modify the data entered in any of the fields (230). When the provider has completed the entries, the provider again transmits the data to the web engine and Steps 222 through 228 are repeated. There is no limit to the number of times that a provider may repeat Steps 222 through 230 before transmitting verified and corrected data to the web engine.

If the web engine determines in Step 228 that a positive option has been selected, the data entered and submitted by the service provider is transmitted in Step 240 to the Schedule Database on the Database Server, where the schedule data is saved as a Schedule Record. This transmission is made in a format that allows the Schedule Database to process the data immediately, which processing may include assigning a Schedule Identifier, adding the corresponding Member Identifier for the particular service provider, and parsing the schedule data for purposes of indexing and subsequent use and review in the system. In one embodiment of the present invention, the saving, indexing, parsing, and processing of the schedule data may occur only after the data has been verified by automated filtering through a filter engine on the Database Server for pre-determined criteria, as described in FIG. 2.

After the data is transmitted and saved in a Schedule Record in Step 240, the service provider is presented with an option to enter another time schedule (242). If the web engine receives a positive option, the web engine repeats the schedule posting procedure commencing at Step 220. If the web engine receives a negative option, the procedure ends and the web engine redisplays the system options presented in Step 150 of FIG. 4.

FIG. 6 illustrates one embodiment of a Schedule Survey Form that is presented to a service provider in Step 220 of FIG. 5 in order for the service provider to enter data relevant to the provider's time schedule and availability and transmit said data to the system. A Schedule Survey Form is generated by the web engine and includes separate fields or dialog boxes for data entry by the service provider. Such fields may include fields or dialog boxes for textual content as typed by the service provider in any format or in limited format, such as pre-determined formats for telephone numbers, dates, or zip codes. They may also include fields containing pre-generated options selectable by the service provider, scroll bars that are moveable to show data, selectable or manipulatable icons, buttons, links, highlightable data, or other selectable data pre-generated by the system and presented to the service provider.

Examples of the fields includable on the Schedule Survey Form are illustrated in the embodiment displayed in FIG. 6. The Form contains fields for contact information (270) and schedule data (272). As an illustration, the provider may enter contact information (270) related to the provider's first, last, and company name into fields that accept textual content freely typed in by the provider. Selectable fields are presented for the provider to choose a description of the provider's profession and to indicate the provider's location by city or county name. The fields for schedule data (272) may include selectable fields for the time, month, day, and year, with an optional icon that will present the service provider with a calendar by which the service provider can select the particular date. The provider may also be able to enter a specific telephone number and email address in textual content fields, which fields may have pre-set formats, thereby verifying that any entry consists of a complete telephone number with area code and a recognizable email address. A textual content field may also be included to allow the service provider to describe time availability, which field may provide scroll bars to allow for review of all data entered. The form generated will include at least one button or other selection indicator. For example, a button may be provided by which the service provider can select to transmit to the system the schedule data entered in the Schedule Survey Form (274), as described in FIG. 5.

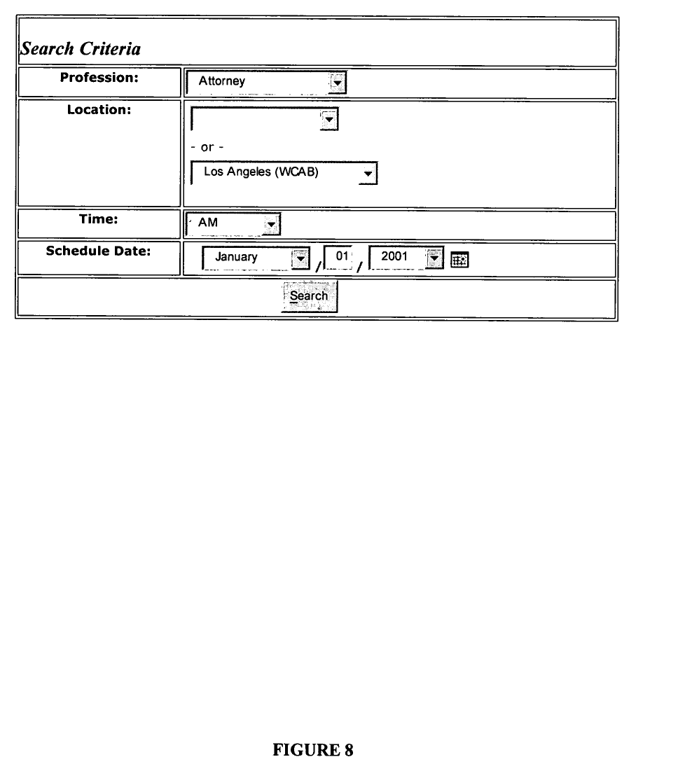

In FIG. 7, the flowchart illustrates a method by which a service or project provider may search and review schedule postings stored in the system. By the time the provider arrives at Step 301, the provider has already accessed the web engine on the Web Server and proceeded to log into the system, if required, as described in FIG. 3, has selected an option to review the system tools as described in Step 150 of FIG. 3, and has selected the option to search or review the schedule posting options as described in Step 300 of FIG. 4. In Step 301, the provider is presented with a description of the procedure and a Schedule Search Form operable by a search engine. One embodiment of such Form is illustrated in FIG. 8. The provider may enter data in the Form and submit the data by means of selecting a button or other transmission indicator displayed on the Form. In Step 310, the schedule data search terms and conditions are received by the web engine and the system compares them to schedule data generated in response to the parsing of schedule data saved in Schedule Records in the Schedule Database on the Database Server, as described in FIG. 2. For example, stored and parsed schedule data for a profession with morning time availability on a particular date may be compared to the search criteria entered in the Schedule Search Form by the provider. In Step 312, schedule identifiers or other links to schedule records associated with the schedule data that match the search criteria entered by the provider are displayed in a results form. The web engine permits the provider to request another search (320), in which event the search procedure is repeated commencing with step 301. If the web engine receives a negative option to a new search request, the procedure terminates and the web engine displays the system options as described in Step 150 of FIG. 4.

Referring to FIG. 8, one embodiment of a Schedule Search Form is illustrated for the present invention. This form may be presented to a project or service provider at Step 301 of the schedule search procedure described in FIG. 7 in order for the provider to enter search terms and conditions by which to locate relevant time schedules stored in the system. The Schedule Search Form is generated by the web engine and includes separate fields or dialog boxes for data entry by the provider. In the embodiment illustrated, only selectable fields are shown by which the provider may search for any one or more of the following criteria: profession, location, time, or date.

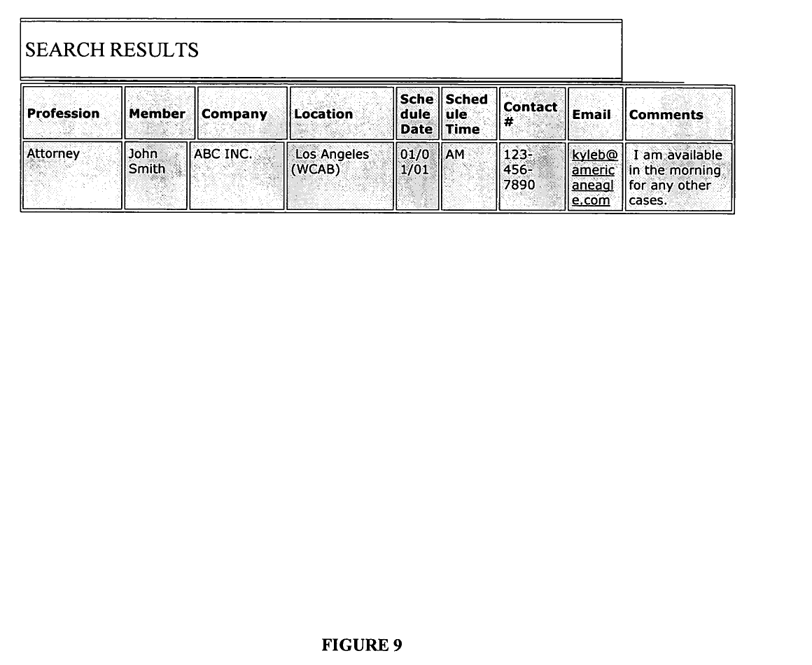

FIG. 9 illustrates one embodiment of a search results form for schedule data, which form may be generated in Step 312 in FIG. 7 for display to a provider who has submitted to the system search terms and conditions relevant to time schedules. In this embodiment, the search results display all of the data saved in the Schedule Record as described in FIG. 6. The data displayed in the search results form may be in such format as to allow the provider to initiate immediate contact with the service provider who has posted a particular time schedule. For example, the email data listed in the results form may be in the form of a hyperlink that permits the provider to send an immediate electronic mail message to the provider offering the service.

FIG. 10 illustrates a flowchart describing a method by which a project provider can enter and submit new project opportunity information into the system of the present invention. By the time the project provider arrives at Step 401, the provider has already accessed the web engine on the Web Server and proceeded to log into the system, if required, as described in FIG. 3, has selected an option to review the system tools as described in Step 150 of FIG. 3, and has selected the option to review the project posting options as described in Step 400 of FIG. 4. At Step 401, the web engine generates a form that describes the project posting options available and allows the provider to select whether or not to enter a new project opportunity into the system. The project provider is also given the opportunity to cancel the procedure, and if the web engine receives a cancellation request, the project posting procedure will end and the web engine will redisplay the system options at Step 150 of FIG. 4.

In Step 410, the project provider makes a selection by means of a button or other indicator to enter a new project. If the web engine determines that a negative option has been received, in Step 590 the web engine generates a form by which the project provider may chose to modify or remove a previous posting stored in the system by the same provider. If the web engine again receives a negative option, the project posting procedure will end and the web engine will redisplay the system options at Step 150 of FIG. 4. If the input received at Step 590 is determined to be a positive option, the provider is presented in Step 600 with a procedure for modifying or deleting postings, which procedure is further described in FIG. 15.

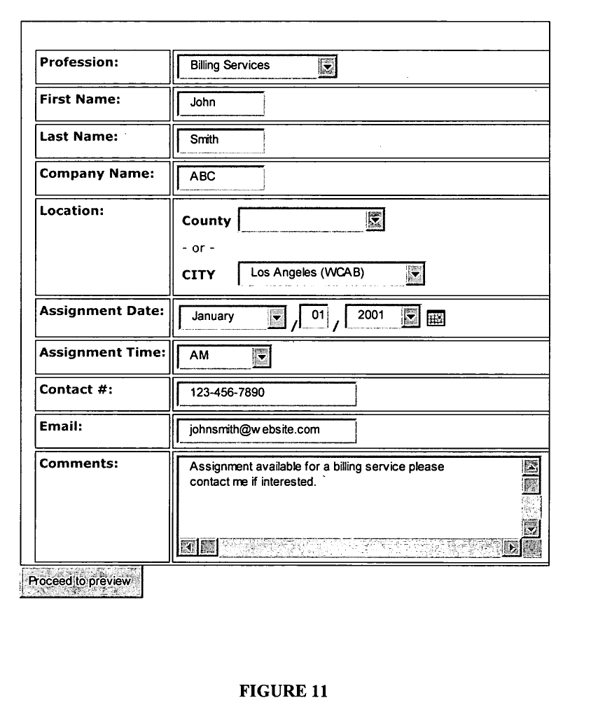

If the web engine determines that the selection input at Step 410 is a positive option, the web engine presents the provider with a Project Survey Form containing fields into which the project provider may enter contact and assignment data. One embodiment of a Project Survey Form is described in FIG. 11. The project provider may choose to cancel the procedure at any time before transmitting data to the web engine by selecting a cancel button or other indicator, in which event the web engine will end the procedure and redisplay the system options at Step 150 of FIG. 4. After the project provider has entered data and completed the Project Survey Form, the provider transmits the data to the web engine by selecting a submit button or other indicator.

In Step 422, the web engine receives the transmitted project data. In Step 424, the web engine generates a Project Form in response to the project data received, which form includes all of the data entered by the provider in Step 420 in separate fields. The generated Project Form is presented to the project provider in Step 426 and the provider is allowed to verify the accuracy of the data entered. At this step, the provider again may select to cancel the project posting procedure, in which event the web engine will end the procedure and redisplay the system options at Step 150 of FIG. 4. If the project provider does not cancel the procedure, the provider must make a selection in Step 428 to correct the data entered or to transmit the data as entered in Step 420. If the web engine determines that the provider has selected a negative option, the web engine redisplays the Project Form generated in Step 424 in a format such that the provider can modify the data entered in any of the fields (430). When the provider has completed the entries, the provider again transmits the data to the web engine and Steps 422 through 428 are repeated. There is no limit to the number of times that a provider may repeat Steps 422 through 430 before transmitting verified and corrected data to the web engine.

If the web engine determines in Step 428 that a positive option has been selected, the data entered and submitted by the project provider is transmitted in Step 440 to the Project Database on the Database Server, where the project data is saved as a Project Record. This transmission is made in a format that allows the Project Database to process the data immediately, which processing may include assigning a Project Identifier, adding the corresponding Member Identifier for the particular project provider, and parsing the project data for purposes of indexing and subsequent use and review in the system. In one embodiment of the present invention, the saving, indexing, parsing, and processing of the project data may occur only after the data has been verified for pre-determined criteria by automated filtering through a filter engine on the Database Server, as described in FIG. 2.

After the data is transmitted and saved in a Project Record in Step 440, the project provider is presented with an option to enter another project opportunity (442). If the web engine receives a positive option, the web engine repeats the project posting procedure commencing at Step 420. If the web engine receives a negative option, the procedure ends and the web engine redisplays the system options presented in Step 150 of FIG. 4.

FIG. 11 illustrates one embodiment of a Project Survey Form that is presented to a project provider in Step 420 of FIG. 10 in order for the project provider to enter data relevant to the provider's project opportunity and transmit said data to the system. A Project Survey Form is generated by the web engine and includes separate fields or dialog boxes for data entry by the project provider. Such fields may include fields or dialog boxes for textual content as typed by the project provider in any format or in limited format, such as pre-determined formats for telephone numbers, dates, or zip codes. They may also include fields containing pre-generated options selectable by the project provider, scroll bars that are moveable to show data, selectable or manipulatable icons, buttons, links, highlightable data, or other selectable data pre-generated by the system and presented to the project provider.

Examples of the fields includable on the Project Survey Form are illustrated in the embodiment displayed in FIG. 11. The Form contains fields for contact information (470) and project data (472). As an illustration, the provider may enter contact information (470) related to the provider's first, last, and company name into fields that accept textual content freely typed in by the provider. Selectable fields are presented for the provider to choose a description of the profession from which services are sought to complete the project, as well as to indicate the provider's location by city or county name. The fields for project data (472) may include selectable fields for the time, month, day, and year of the project opportunity, with an optional icon that will present the provider with a calendar by which the provider can select the particular date. The provider may also be able to enter a specific telephone number and email address in textual content fields, which fields may have pre-set formats, thereby verifying that any entry consists of a complete telephone number with area code and a recognizable email address. A textual content field may also be included to allow the project provider to describe specific features of the project or otherwise to make other comments, which field may provide scroll bars to allow for review of all data entered. The form generated will include at least one button or other selection indicator. For example, a button may be provided by which the project provider can select to transmit to the system the project data entered in the Project Survey Form (474), as described in FIG. 10.

The flowchart in FIG. 12 illustrates a method by which a service or project provider may search and review project postings stored in the system. By the time the provider arrives at Step 501, the provider has already accessed the web engine on the Web Server and proceeded to log into the system, if required, as described in FIG. 3, has selected an option to review the system tools as described in Step 150 of FIG. 3, and has selected the option to search or review the schedule posting options as described in Step 500 of FIG. 4. In Step 501, the provider is presented with a description of the procedure and a Project Search Form operable by a search engine. One embodiment of such Form is illustrated in FIG. 11. The provider may enter data in the Form and submit the data by means of selecting a button or other transmission indicator displayed on the Form. In Step 510, the project data search terms and conditions are received by the web engine and the system compares them to project data generated in response to the parsing of project data saved in Project Records in the Project Database on the Database Server, as described in FIG. 2. For example, stored and parsed data for a project that requires a certain professional qualification, that must be accomplished at a certain time and date, and that is available in a particular location may be compared to the search criteria entered in the Project Search Form by the provider. In Step 512, project identifiers or other links to project records associated with the project data that match the search criteria entered by the provider are displayed in a results form. The web engine permits the provider to request another search (520), in which event the search procedure is repeated commencing with step 501. If the web engine receives a negative option to a new search request, the procedure terminates and the web engine displays the system options as described in Step 150 of FIG. 4.

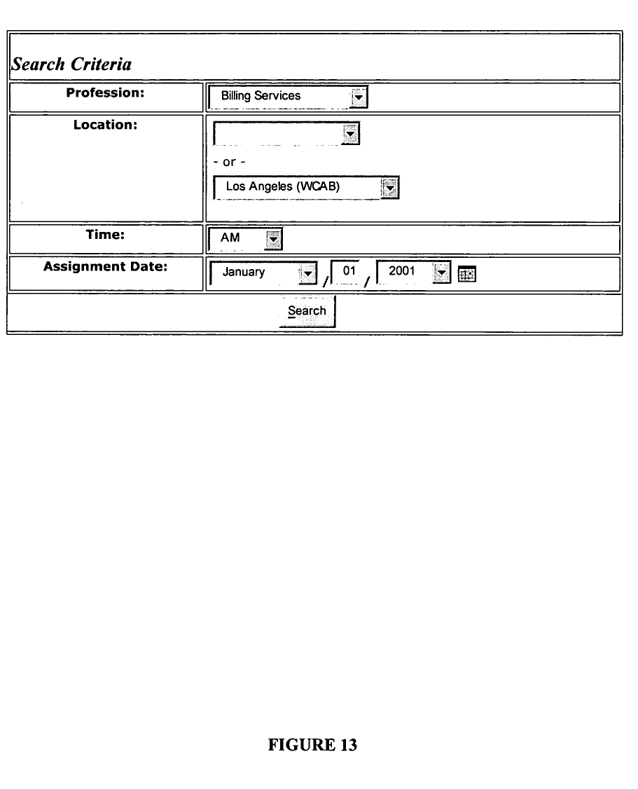

FIG. 13 constitutes one embodiment of a Project Search Form for the present invention. This form may be presented to a project or service provider at Step 501 of the project search procedure described in FIG. 12 in order for the provider to enter search terms and conditions by which to locate relevant project opportunities stored in the system. The Project Search Form is generated by the web engine and includes separate fields or dialog boxes for data entry by the provider. In the embodiment illustrated, only selectable fields are shown by which the provider may search for any one or more of the following criteria: profession, location, time, or date.

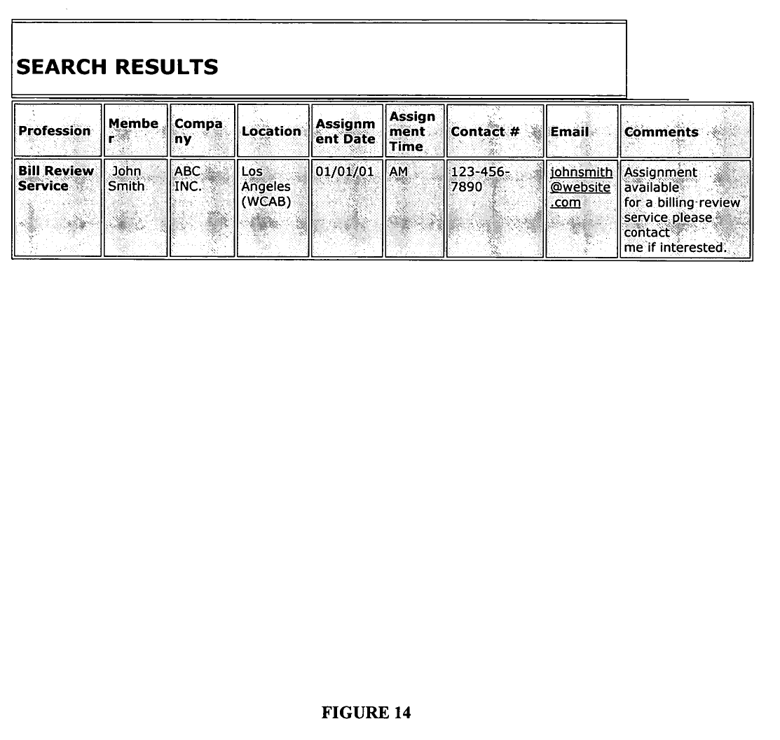

FIG. 14 illustrates one embodiment of a search results form for project data, which form may be generated in Step 412 in FIG. 12 for display to a provider who has submitted to the system search terms and conditions relevant to project opportunities. In this embodiment, the search results display all of the data saved in the Project Record as described in FIG. 11. The data displayed in the search results form may be in such format as to allow the provider to initiate immediate contact with the project provider who has posted a particular project opportunity. For example, the email data listed in the results form may be in the form of a hyperlink that permits the provider to send an immediate electronic mail message to the provider offering the project.

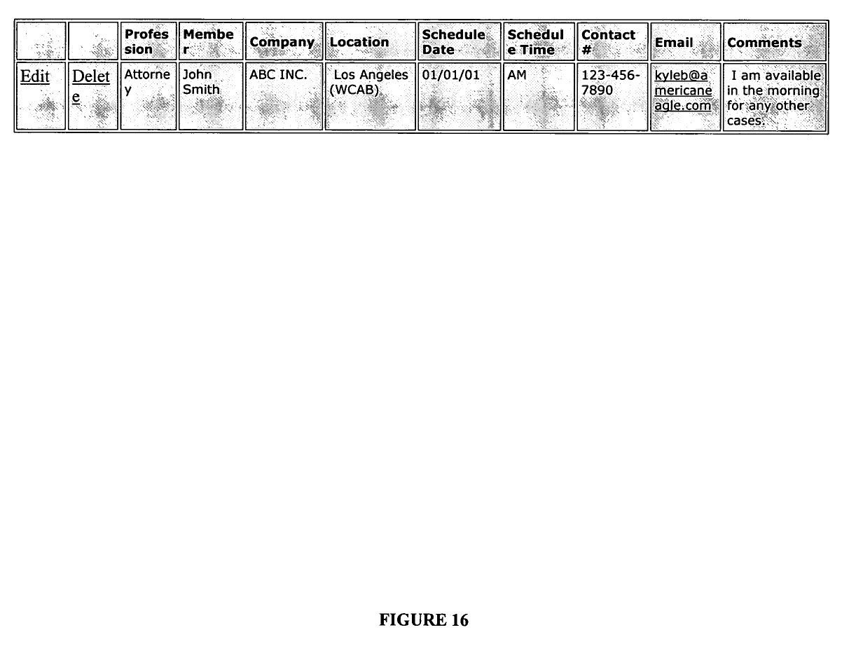

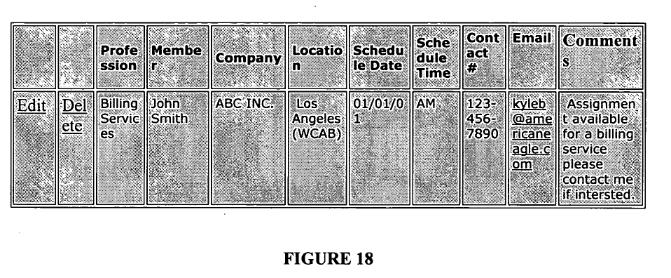

Referring to FIG. 15, a flowchart is provided to illustrate a method by which a service or project provider can enter modifications to previously posted data or can delete a stored record entirely. This procedure is made available to any provider who has previously utilized the system to post schedule or project data. By the time the provider arrives at Step 601, the provider has already accessed the web engine on the Web Server and proceeded to log into the system, if required, as described in FIG. 3, has selected an option to review the system tools as described in Step 150 of FIG. 3, and has selected the user or member posting option as described in Step 600 of FIG. 4. At Step 601, the web engine utilizes the provider's identifier stored in the system (see FIG. 3) to generate a list of the records that the provider has submitted to the system for storage. These records may be schedule records or project records. For each record listed, all of the fields of the record are displayed for the provider's review, as illustrated in FIGS. 16 and 18. The provider also has an option to cancel this procedure, in which event the procedure will end (680) and the system will redisplay the system options to the provider as shown in Step 150 of FIG. 4.

At Step 610, the system presents the provider with an option to edit a record. If the web engine receives a negative option from the provider, the system presents the provider with an option to delete a posted record (630). At step 630, if the provider submits a negative option or cancellation request, the system returns the provider to Step 601, from where the provider may request to cancel the procedure (680). If at Step 630, the provider selects a positive option to delete a record, that request is submitted to the system, which receives and processes the request (632). As part of the processing, the system may request the provider to confirm the delete request, although this step is not required. In Step 634, the web engine transmits the delete request for the particular record identifier to the schedule or project database on the Database Server, where the respective database engine updates the respective database by deletion of the identified record. The system then displays a message to the provider confirming deletion and the provider is presented with an option to modify another posting or to cancel the procedure (660). If the web engine receives a negative option from the provider, the procedure is cancelled and the system redisplays the system options at Step 150 of FIG. 4. If the web engine receives a positive option, the system repeats the modification procedure commencing with Step 601.

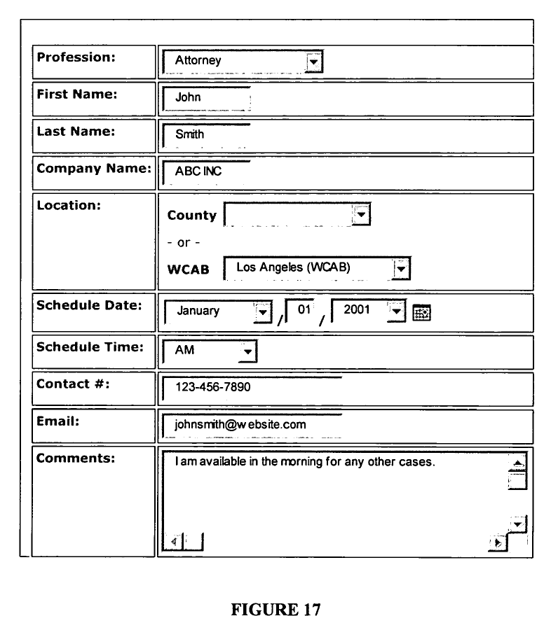

In Step 610, the provider may select to edit a posted record by means of a button or other indicator. If the input received at Step 612 is determined to be a positive option, the system generates a form for editing purposes (614) and presents it to the provider. The form presented to the provider will be either a Schedule Modification Survey Form or a Project Modification Survey Form, depending on whether the provider has selected a schedule or project record to be edited in Step 610. The Modification Survey Form contains fields into which the provider may enter modifications to the previously entered data. One embodiment of a Schedule Modification Survey Form is described in FIG. 17. One embodiment of a Project Modification Survey Form is described in FIG. 18.

After the provider has entered data and completed the Modification Survey Form presented in Step 612, the provider transmits the data to the web engine by selecting a submit button or other indicator. In Step 614, the web engine receives the transmitted data and generates a Schedule or Project Form, respectively, in response to the data received, which form includes in separate fields all of the data as modified and entered by the provider in Step 612. The Form generated is dependent on whether the provider modified data in a Schedule Record or in a Project Record. The generated Form is presented to the provider in Step 616 and the provider is allowed to verify the accuracy of the data entered. At this step, the provider again may select to cancel the modification procedure, in which event the web engine will end the procedure and redisplay the system options at Step 150 of FIG. 4. If the service provider does not cancel the procedure, the provider must make a selection in Step 618 to correct the data entered or to transmit the data as entered in Step 612.

If the web engine determines that the provider has selected a negative option at Step 618, the web engine redisplays the Schedule or Project Form generated in Step 614 in a format such that the provider can again modify the data entered in any of the fields (640). When the provider has completed the entries, the provider again transmits the data to the web engine and Steps 612 through 618 are repeated. There is no limit to the number of times that a provider may repeat Steps 612 through 640 before transmitting verified and corrected data to the web engine.

If the web engine determines in Step 618 that a positive option has been selected, the data 30 entered and submitted by the service provider is transmitted in Step 650 to the Schedule Database or the Project Database, respectively, on the Database Server, where the record in the respective database is updated. The database that receives the transmission is dependent on whether the provider has selected to modify a schedule or a project record in Step 610. The record that is updated is determined by the system by means of the record identifier, which will be the identifier assigned to the schedule record or to the project record when it was first created. This procedure is described in FIGS. 6 and 10, respectively. The website transmits the data in Step 650 in a format that allows the database to process the data immediately and to update the stored records. In one embodiment of the present invention, the update processing may occur only after the data has been verified by automated filtering through a filter engine on the Database Server for pre-determined criteria, as described in FIG. 2.

After the data is transmitted and the stored record is updated in Step 650, the provider is presented with an option to modify another posted record (660). If the web engine receives a positive option, the web engine repeats the modification procedure commencing at Step 601. If the web engine receives a negative option, the procedure ends and the web engine redisplays the system options presented in Step 150 of FIG. 4.

FIG. 16 illustrates one embodiment of a Schedule Record List Form that is presented to a service provider in Step 601 of FIG. 15 in order for the service provider to modify or delete data stored in a Schedule Record of the Schedule Database on the Database Server. The List Form is generated by the system by means of comparing the Member Identifier for the provider, which Identifier was assigned when the Member submitted a Member Profile as described in FIG. 3, to the field in each Schedule Record stored in the Schedule Database, which fields were completed at the time the provider initially posted the record, as described in FIG. 6. The List Form displays in separate columns all of the data for each record located by said comparison process. In this embodiment, the first two columns of each listed record include the two option indicators that the provider can select for purposes of choosing whether to edit or delete a particular record, as described in FIG. 15. If the provider selects the edit indicator, the system will generate a Schedule Modification Survey Form, as illustrated in FIG. 17.

In FIG. 17, one embodiment of the Schedule Modification Survey Form is illustrated. This Form is generated by the system of the present invention in Step 612 of FIG. 15 to allow a provider utilizing the system to modify a schedule record previously posted and currently stored in the Schedule Database on the Database Server for the system. This Form includes the same selectable and textual fields as are displayed to the provider in the Schedule Survey Form (see FIG. 6) when the provider initially selects to enter schedule data into the system, as described in FIG. 5, except that the system copies the data stored in the fields of the particular record into the fields generated for the Modification Survey Form. The provider is then able to review the copied data and make modifications to it as needed. The modification procedure is described in FIG. 15.

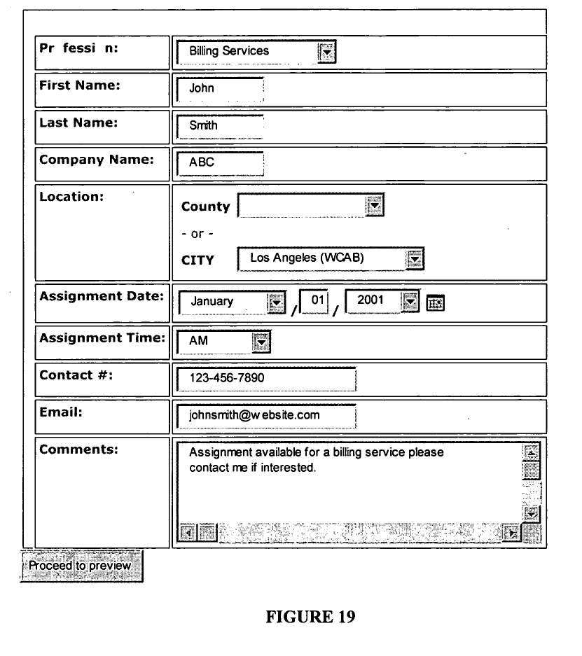

FIG. 18 illustrates one embodiment of a Project Record List Form that is presented to a project provider in Step 601 of FIG. 15 in order for the project provider to modify or delete data stored in a Project Record of the Project Database on the Database Server. The List Form is generated by the system by means of comparing the Member Identifier for the provider, which Identifier was assigned when the Member submitted a Member Profile as described in FIG. 3, to the field in each Project Record stored in the Project Database, which fields were completed at the time the provider initially posted the record, as described in FIG. 10. The List Form displays in separate columns all of the data for each record located by said comparison process. In this embodiment, the first two columns of each listed record include the two option indicators that the provider can select for purposes of choosing whether to edit or delete a particular record, as described in FIG. 15. If the provider selects the edit indicator, the system will generate a Project Modification Survey Form, as illustrated in FIG. 19.

In FIG. 19, one embodiment of the Project Modification Survey Form is illustrated. This Form is generated by the system of the present invention in Step 612 of FIG. 15 to allow a provider utilizing the system to modify a project record previously posted and currently stored in the Project Database on the Database Server for the system. This Form includes the same selectable and textual fields as are displayed to the provider in the Project Survey Form (see FIG. 11) when the provider initially selects to enter project data into the system, as described in FIG. 10, except that the system copies the data stored in the fields of the particular record into the fields generated for the Modification Survey Form. The provider is then able to review the copied data and make modifications to it as needed. The modification procedure is described in FIG. 15.

Although the present invention has been described in detail, various changes, substitutions, and alterations can be made in the system without departing from the intent and scope of the invention as defined by the appended claims.

1. A system for automated coordination of time schedules and availability with job, assignment, or project opportunities using a network, the system comprising:
a web engine operable to communicate with the network and to present a schedule survey form to a client of the network, the web engine further operable to receive from the client schedule data that is entered in the form; and
a web engine operable to communicate with the network and to present a project survey form to a client of the network, the web engine further operable to receive from the client project data that is entered in the form; and
a schedule mapping engine in communication with the schedule web engine, the schedule mapping engine operable to receive the schedule data from the schedule web engine and to generate at least one schedule identifier in response to parsing the schedule data, the schedule mapping engine further operable to index the at least one schedule identifier in response to the parsed schedule data, the at least one schedule identifier being linked to a schedule record, which schedule record stores the schedule data; and
a project mapping engine in communication with the project web engine, the project mapping engine operable to receive the project data from the project web engine and to generate at least one project identifier in response to parsing the project data, the project mapping engine further operable to index the at least one project identifier in response to the parsed project data, the at least one project identifier being linked to a project record, which project record stores the project data.

2. The system of claim 1, further comprising a filter engine in communication with the schedule and project web and mapping engines, the filter engine operable to control communication of the schedule and project data between the web engines and the mapping engines.

3. The system of claim 1, further comprising a schedule index having categories corresponding to the schedule data, the schedule mapping engine being operable to index the at least one schedule identifier by assigning the at least one schedule identifier to one of the schedule index categories in response to comparing the schedule data corresponding to the one category to the parsed schedule data.

4. The system of claim 3, wherein the schedule survey form includes at least one selectable input field, each selectable input corresponding to the schedule data of a category in the schedule index.

5. The system of claim 1, further comprising a project index having categories corresponding to the project data, the project mapping engine being operable to index the at least one project identifier by assigning the at least one project identifier to one of the project index categories in response to comparing the project data corresponding to the one category to the parsed project data.

6. The system of claim 5, wherein the project survey form includes at least one selectable input field, each selectable input corresponding to the project data of a category in the project index.

7. The system of claim 1, wherein the schedule web engine includes a schedule review template, and wherein the schedule web engine is operable to:
map schedule data from the fields in the schedule survey form to fields in the schedule review template;
communicate the schedule review template to a client of the network; and
modify schedule data in the fields of the schedule survey form in response to receiving modifications from the client to the fields of the schedule review template.

8. The system of claim 1, wherein the project web engine includes a project review template, and wherein the project web engine is operable to:
map project data from the fields in the project survey form to fields in the project review template;
communicate the project review template to a client of the network; and
modify project data in the fields of the project survey form in response to receiving modifications from the client to the fields of the project review template.

9. The system of claim 1, wherein the schedule mapping engine further includes a schedule modification template, and wherein the schedule mapping engine is operable to:
map schedule data from the schedule record to fields in the schedule modification template;
communicate the schedule modification template to a client of the network; and
modify schedule data in the schedule record in response to receiving modifications to the fields of the schedule modification template.

10. The system of claim 1, wherein the project mapping engine further includes a project modification template, and wherein the project mapping engine is operable to:
map project data from the project record to fields in the project modification template; and
communicate the project modification template to a client of the network; and
modify project data in the project record in response to receiving modifications to the fields of the project modification template.

11. The system of claim 1, further comprising a provider member or registrant web engine operable to communicate with the network and to present a provider profile form to a client of the network, the web engine further operable to receive from the client the provider profile data that is entered in the form.

12. The system of claim 11, further comprising a provider mapping engine in communication with the provider member or registrant web engine, the provider mapping engine operable to receive the provider profile data from the provider member or registrant web engine and to generate at least one provider identifier in response to parsing the provider profile data, the provider mapping engine further operable to index the at least one provider identifier in response to the parsed provider profile data, the at least one provider identifier being linked to a provider record, which provider record stores the provider data, and being linked to one or more schedule or project records received from the client provider.

13. The system of claim 11, further comprising a filter engine in communication with the provider member or registrant web engine and the provider mapping engine, the filter engine operable to control communication of the provider profile data between the web engine and the mapping engine.

14. The system of claim 11, further comprising a provider index having categories corresponding to the provider profile data, the provider mapping engine being operable to index the at least one provider identifier by assigning the at least one provider identifier to one of the provider index categories in response to comparing the provider data corresponding to the one category to the parsed provider data.

15. The system of claim 11, wherein the provider member or registrant web engine includes a provider review template, and wherein the provider member or registrant web engine is operable to:
map provider profile data from the fields in the provider profile form to fields in the provider review template;
communicate the provider review template to a client of the network; and
modify provider profile data in the fields of the provider profile form in response to receiving modifications from the client to the fields of the provider review template.

16. The system of claim 11, wherein the provider mapping engine further includes a provider profile modification template, and wherein the provider mapping engine is operable to:
map provider profile data from the provider record to fields in the provider profile modification template;
communicate the provider profile modification template to a client of the network; and
modify provider profile data in the provider record in response to receiving modifications to the fields of the provider profile modification template.

17. The system of claim 11, wherein the provider mapping engine further includes a plurality of versions of the provider review template, the provider mapping engine being operable to determine a selected one of the plurality of versions to be communicated to a client of the network in response identification data received from the client, each version of said template displaying different fields of information associated with the provider record.

18. The system of claim 11, further comprising a message board, said message board being indexed by topic, wherein providers and clients can communicate with each other by means of posting electronic messages on said message board.

19. A method of automated coordination of time schedules and availability with job, assignment, and project opportunities, the method comprising:
parsing schedule data from a schedule survey in response to receiving the schedule data over the network;
parsing project data from a project survey in response to receiving the project data over the network;
storing the received schedule data in a schedule record;
storing the received project data in a project record;
generating a plurality of schedule identifiers related to the parsed schedule data, each schedule identifier being linked to a schedule record;
generating a plurality of project identifiers related to the parsed project data, each project identifier being linked to a project record;
comparing the schedule data to schedule data categories of a schedule index;
comparing the project data to project data categories of a project index;
assigning each of the schedule identifiers to a schedule data category in response to the compared schedule data; and
assigning each of the project identifiers to a project data category in response to the compared project data.

20. The method of claim 19, the method further comprising filtering the received schedule survey, and wherein parsing the schedule data is in response to filtering the schedule survey.

21. The method of claim 19, the method further comprising filtering the received project survey, and wherein parsing the project data is in response to filtering the project survey.

22. The method of claim 19, further comprising:
receiving an input from a client of the network, the input selecting at least one schedule identifier from the schedule index; and
updating a schedule record with a copy of the schedule identifier in response to receiving the client's input.

23. The method of claim 19, further comprising:
receiving an input from a client of the network, the input selecting at least one project identifier from the project index; and
updating a project record with a copy of the project identifier in response to receiving the client's input.

24. The method of claim 19, further comprising:
parsing provider profile data from a provider survey in response to receiving the provider profile data over the network;
storing the received provider profile data in a provider record;
generating a plurality of provider identifiers related to the parsed provider profile data, each provider identifier being linked to the provider record;
comparing the provider profile data to a provider index; and
assigning one or more provider identifiers to a category of the provider index in response to the compared provider profile data.

25. The method of claim 24, the method further comprising filtering the received provider survey, and wherein parsing the provider profile data is in response to filtering the provider survey.

26. The method of claim 24, further comprising:
receiving an input from a client of the network, the input selecting at least one provider identifier from the provider index; and
updating a provider record with a copy of the provider identifier in response to receiving the client's input.

27. The method of claim 24, further comprising a message board, said message board being indexed by topic, wherein providers and clients can communicate with each other by means of posting electronic messages on said message board.

28. A system for automated coordination of time schedules and availability information with job, assignment, and project opportunities, the system comprising:
a computer-readable medium; and
a computer program encoded on the computer-readable medium, the computer program operable to be executed on a computer, the computer program further operable to:
parse schedule data from a schedule survey in response to receiving the schedule data;
parse project data from a project survey in response to receiving the project data;
store the received schedule data in a schedule record;
store the received project data in a project record;
generate a plurality of schedule identifiers related to the parsed schedule data, each schedule identifier being linked to a schedule record;
generate a plurality of project identifiers related to the parsed project data, each project identifier being linked to a project record;
compare the schedule data to schedule data categories of a schedule index;
compare the project data to project data categories of a project index;
assign each of the schedule identifiers to a schedule data category in response to the compared schedule data; and
assign each of the project identifiers to a project data category in response to the compared project data.

29. The system of claim 28, wherein the computer program is further operable to filter the schedule survey and wherein the computer program parses the schedule data in response to filtering the schedule survey.

30. The system of claim 28, wherein the computer program is further operable to filter the project survey and wherein the computer program parses the project data in response to filtering the project survey.

31. The system of claim 28, wherein the computer program is further operable to receive an input from a client, the input selecting at least one schedule identifier from the schedule index and to update a schedule record with a copy of the schedule identifier in response to receiving the input.

32. The system of claim 28, wherein the computer program is further operable to receive an input from a client, the input selecting at least one project identifier from the project index and to update a project record with a copy of the project identifier in response to receiving the input.

33. The system of claim 28, wherein the computer program is further operable to:
receive from a client schedule criterion input by the client;
compare the schedule search criteria to the schedule data associated with the categories of the schedule index;
select each schedule identifier assigned to the categories in response to comparing the schedule search criteria; and
display to the client the schedule data of each schedule record for each selected schedule identifier.

34. The system of claim 28, wherein the computer program is further operable to:
receive from a client project criterion input by the client;
compare the project search criteria to the project data associated with the categories of the project index;
select each project identifier assigned to the categories in response to comparing the project search criteria; and
display to the client the project data of each project record for each selected project identifier.

35. The system of claim 28, wherein the computer program is further operable to:
parse provider profile data from a provider profile in response to receiving the provider profile data over the network;
store the received provider profile data in a provider record;
generate a plurality of provider identifiers related to the parsed provider profile data, each provider identifier being linked to the provider record;
compare the provider profile data to a provider index; and
assign one or more provider identifiers to a category of the provider index in response to the compared provider profile data.

36. The system of claim 33, wherein the computer program is further operable to filter the received provider survey and to parse the provider profile data in response to filtering the provider survey.

37. The system of claim 33, wherein the computer program is further operable to receive an input from a client, the input selecting at least one provider identifier from the provider index and to update a provider record with a copy of the provider identifier in response to receiving the input.

38. The system of claim 33, wherein the computer program is further operable to:
receive from a client provider criterion input by the client;
compare the provider search criteria to the provider data associated with the categories of the provider index;
select each provider identifier assigned to the categories in response to comparing the provider search criteria; and
display to the client the provider profile data of each provider record for each selected provider identifier.

39. The system of claim 33, further comprising a message board, said message board being indexed by topic, wherein providers and clients can communicate with each other by means of posting electronic messages on said message board.
